(19) United States
(12) Patent Application Publication
(10) Pub. No.: US 2011/0260875 A1
(43) Pub. Date: Oct. 27, 2011

(54) ALERT DEVICE AND METHOD

(75) Inventors: Ronaldus Maria AARTS, Geldrop (NL); Joris Adelbert Maria NIEUWENDIJK, Eindhoven (NL); Okke OUWELTJES, Veldhoven (NL)

(73) Assignee: KONINKLIJKE PHILIPS ELECTRONICS, N.V., EINDHOVEN (NL)

(21) Appl. No.: 12/764,159

(22) Filed: Apr. 21, 2010

(51) Int. Cl. G08B 21/00; H04R 1/02; G08B 3/00

(52) U.S. Cl. 340/627; 340/384.1; 381/386

(57) ABSTRACT

An alert device and method include an elongated cavity (306) and a loudspeaker (302) coupled to a first end portion of the cavity wherein sound produced by the loudspeaker is directed through the cavity to provide an audible sound. The cavity and the loudspeaker are configured and dimensioned to provide the audible sound substantially at an anti-resonant frequency (F_{b}) between first and second resonant frequency peaks for system impedance in a response spectrum for the loudspeaker and the cavity.

This disclosure relates to an alert device and method and more particularly to a high efficiency loudspeaker alarm that is light weight, compact and low-cost with improved audibility.

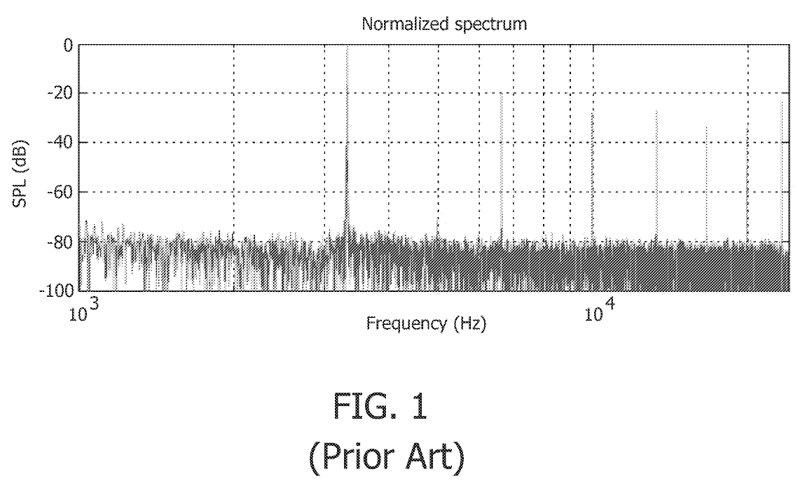

Typical fire alarms, and in particular those for domestic use, are small devices designed to alert people in case of fire or other harmful conditions like smoke or high levels of carbon monoxide. Conventional designs include a cylindrical shaped alarm with a sensor and a speaker in the front face. The design is usually about 10-15 cm in thickness although this can vary with the design. An acoustical generator or speaker of these devices is usually a piezoelectric disk because it is compact and inexpensive. A typical acoustic response of a conventional fire alarm/smoke detector device is shown in FIG. 1.

Referring to FIG. 1, a normalized frequency spectrum is shown where sound pressure level (SPL in dB) is plotted against frequency (Hz). Note the peak response just greater than 3 kHz. One problem with the sound generator of conventional alarms is that the main frequency is usually around 3 kHz and is so high that it is easily damped by walls and doors. At this frequency the signal is not sufficiently audible for people who are sleeping. This problem is compounded if the fire alarm/smoke detector is not in a bedroom or the area where the individuals are sleeping, or if the fire alarm/smoke detector is located in a different floor in the house.

Many governments demand that the sound level at a bed pillow should be between at least 70 or 75 dBA for smoke detectors/fire alarms. Despite this requirement, the problem becomes more severe for those with hearing deficiencies or if the threshold of hearing has risen, which is common as one gets older.

D. Bruck and M. Ball (hereinafter Bruck), in “Sleep and fire: Who is at risk and can the risk be reduced?”, Proceedings of the 8th International Symposium of the International Association for Fire Safety Science, Beijing, September 2005, describes increased risk factors regarding fire safety. The following is a quote from Bruck, where the references shown as numbers between brackets are the references in the Bruck paper and not from the current document.

“However, it is hypothesized that sleep becomes a substantial risk for fire death if additional risk factors are present. Studies of smoke alarms and sleep tell us that significant “staying asleep” risk factors include;

having high levels of background noise,

being a heavy sleeper,

being sleep deprived,

being a child,

being under the influence of sleeping tablets,

being alcohol intoxicated (even moderate, 0.05 BAC),

hearing impairment (for high pitch signals this includes many people over 60)

As these risk factors mean that on any one night a considerable section of the population have an increased chance of sleeping through fire cues or an alarm signal, the issue of what type of alarm signal is optimum must be addressed. Fortunately, the studies that have compared the waking effectiveness of different alarms draw the same conclusions. The evidence from studies using young children, sober adults and alcohol intoxicated adults suggest that such individuals are more likely to awaken to low frequency signals at a lower volume compared to high frequency signals. Both a low pitch T-3 beeping signal and the female voice alarm elicited a behavioral response in sober adults at around 13 dBA less volume than a high pitched alarm [10]. Similarly, the likelihood of a 6 to 10 year old waking to a low pitched T-3 or voice alarm is almost twice as great as awakening to a high pitch alarm at the same loud volume [27]. It is possible that the critical optimal frequencies are those within the same pitch range as the human voice (2500 Hz or less), although one study on the responsiveness of neonates during sleep [35] suggests lower frequencies (120-250 Hz) are optimal. People representing hard of hearing individuals advocate a tone between 100 and 700 Hz [36].”

Conventional acoustic alarms do not provide optimal amplitude or frequency response due to their size and cost requirements. Such conventional designs mainly make use of a piezo disk, which has the disadvantages mentioned above, or employ loudspeakers mounted into a (folded) horn which suffer from the same limitations. Therefore a need exists for an improved alarm device.

In accordance with the present principles, an alarm device is provided which includes an improved response that is less attenuated then the conventional designs and provides a lightweight, compact design that is cost effective. The improved device may employ multi-tone signals, which can be radiated simultaneously and efficiently from a compact device. In one embodiment, the conventional piezo disk sound generator is replaced with a small but very high efficiency loudspeaker. The small loudspeaker can be mounted in a tube and is capable of producing more than one tone at the same time. In another embodiment, the loudspeaker is employed to render voice messages. One advantage of doing this is that a low cost, compact and light weight alarm with improved audibility for the hearing impaired, or in difficult conditions like damping by walls is provided.

An alert device and method include an elongated cavity and a loudspeaker coupled to a first end portion of the cavity wherein sound produced by the loudspeaker is directed through the cavity to provide an audible sound. The cavity and the loudspeaker are configured and dimensioned to provide the audible sound substantially at an anti-resonant frequency between first and second resonant frequency peaks for system impedance in a response spectrum for the loudspeaker and the cavity.

A detector device includes a triggering device configured to trigger an alarm signal in accordance with a condition. An alert device includes a tube and a loudspeaker coupled to a first end portion of the tube wherein sound produced by the loudspeaker is directed through the tube to provide an audible sound, the tube and the loudspeaker are configured and dimensioned to provide the audible sound substantially at an anti-resonant frequency between first and second resonant frequency peaks for system impedance in a response spectrum for the loudspeaker and the tube. A controller is coupled to the triggering device and configured to activate the alert device in accordance with the alarm signal.

A method for sounding an alarm includes providing an alert device including an elongated cavity and a loudspeaker coupled to a first end portion of the cavity wherein sound produced by the loudspeaker is directed through the cavity to provide an audible sound. The cavity and the loudspeaker are configured to provide the audible sound substantially at an anti-resonant frequency between first and second resonant frequency peaks for system impedance in a response spectrum for the loudspeaker and the cavity. The audible sound is generated by activating the loudspeaker.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

FIG. 1 is a diagram showing a frequency response spectrum for a conventional fire alarm piezo disk speaker;

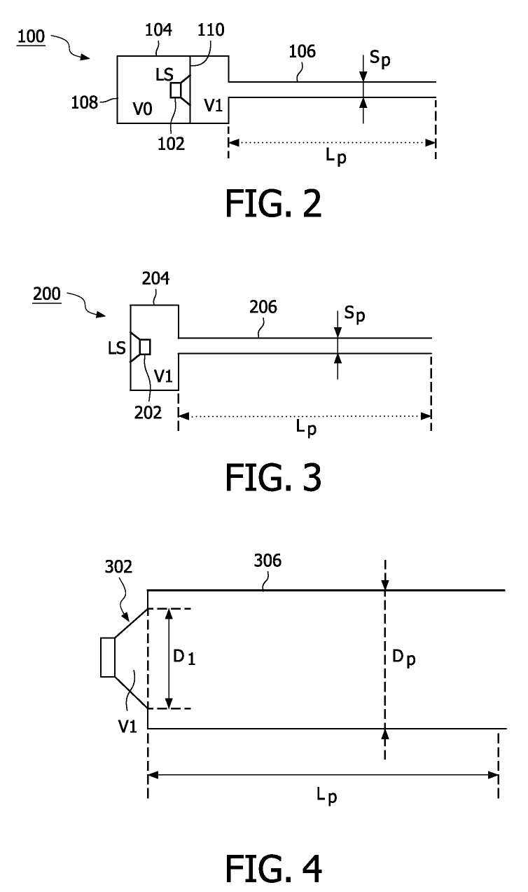

FIG. 2 is a cross-sectional view of an alert/alarm device having a band-pass enclosure in accordance with one embodiment;

FIG. 3 is a cross-sectional view of an alert/alarm device having a reflex enclosure in accordance with another embodiment;

FIG. 4 is a cross-sectional view of an alert/alarm device which was prototyped and tested in accordance with one embodiment;

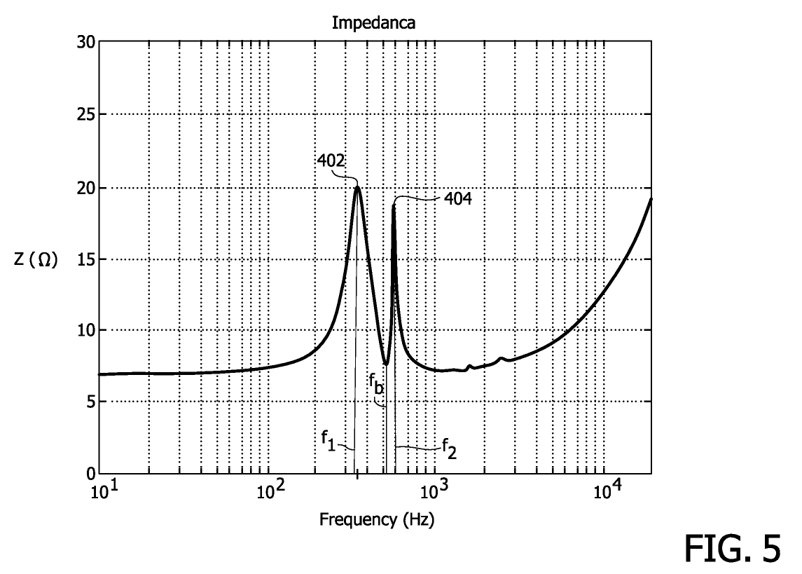

FIG. 5 is a plot of impedance versus frequency showing an anti-resonant frequency in accordance with one embodiment;

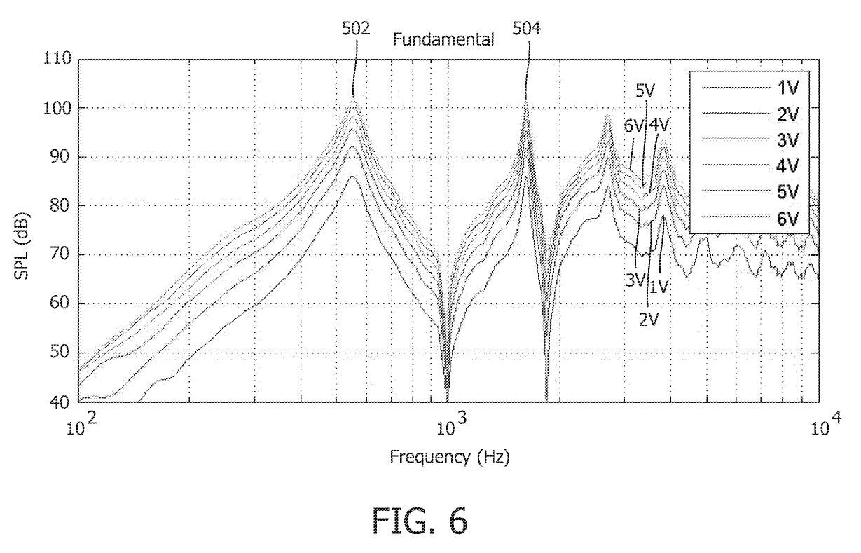

FIG. 6 is a plot of sound pressure level (dB) versus frequency for a fundamental harmonic for the device of FIG. 4;

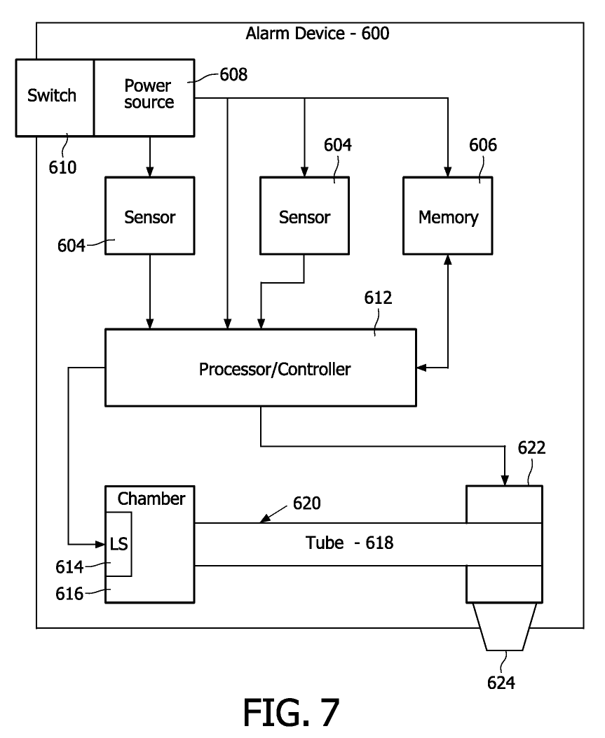

FIG. 7 is a schematic diagram showing a system for producing an alert/alarm in accordance with a triggering event; and

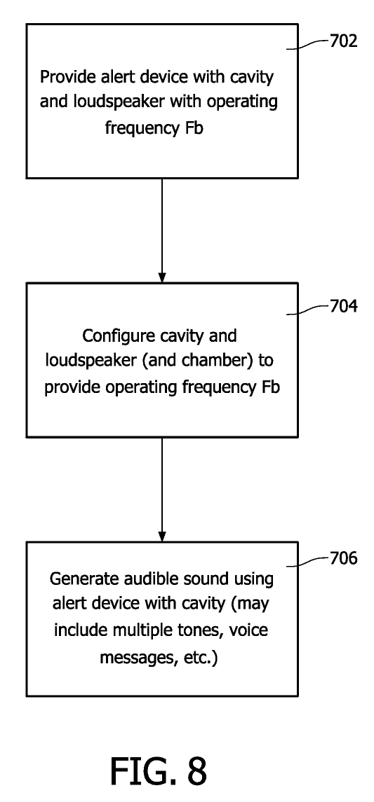

FIG. 8 is a flow diagram for a method for sounding an alarm in accordance with one embodiment.

The present disclosure describes alert/alarm devices and in particular domestic use alarm devices for smoke detectors, fire alarms, burglar alarms or other alert systems. It should be understood that the present embodiments will be described in terms of compact alarm devices; however, the teachings of the present disclosure are much broader and are applicable to any components that can be employed for rendering acoustic waves. For example, for public address systems, car horns, sirens, etc. Embodiments described herein are preferably employed for domestic use as advantages are provided that reduce acoustic attenuation in domestic environments. However, as stated above, domestic use is illustrative of a single application. Other applications may include air horns, signaling devices or the like used in any environment.

The alarm device may be fabricated from a plurality of different materials such as metal (e.g., steel, brass), wood, plastic or any other suitable material. In one embodiment plastic is preferable for fabrication of a tube of the device since plastic is cost effective, easily molded to form and is environmentally resistant to decomposition.

It should also be understood that the illustrative example of the alarm device may be adapted to include electronic components, software modules and a plurality of different power sources. These components may be mounted in the alarm device or on other components. The electrical elements may be programmable and include a plurality of different sensor types. The elements depicted in the FIGS. may be implemented in various combinations and provide functions which may be combined in a single element or multiple elements.

Referring now to the drawings in which like numerals represent the same or similar elements and initially to FIG. 2, an alarm device 100 is shown in accordance with one illustrative embodiment. Device 100 includes a first chamber 104, which forms a band-pass enclosure configured to receive a loudspeaker 102. Loudspeaker 102 is preferably small enough to be mounted directly to an inside diameter of the first chamber 104. Chamber 104 may be separated into two volumes V0 and V1. Volume V0 is bounded by sidewalls of the chamber 104, rear wall 108 and the loudspeaker 102 or an optional plate 110 on which the loudspeaker is mounted. The plate 110 may be employed to adapt to different loudspeakers 102 for placement inside chamber 104. Volume V1 fluidly and acoustically communicates with an open cavity 106. Cavity 106 may include a tube or pipe and includes an internal cross-section of Sₚ, which can be of any shape. Cavity 106 is Lₚ in length.

In an alternate embodiment as depicted in FIG. 3, a device 200 includes a loudspeaker 202 mounted in a chamber 204. Chamber 204 forms a reflex enclosure with a long port or pipe 206. A separate volume V0 is eliminated. Pipe or tube 206 includes an internal cross-section of Sₚ, which can be of any shape. Cavity 206 is Lₚ in length.

Referring to FIG. 4, to obtain a high efficiency, one alternate embodiment may mount a loudspeaker/driver 302 in a tube 306 such that a diameter D1 of the driver 302 is smaller than a diameter Dp of the tube 306. In this case volume, V₁ could be eliminated or minimized depending on the desired frequency response.

In FIGS. 2, 3 and 4, the pipe 106, 206 or 306 may be any shaped elongated cavity. The chamber, loudspeaker and cavity are designed to have high efficiently, which is achieved since the cavity of the tube acts as an acoustical resonator. The system needs to have low damping (high Q, see, e.g., peak 502 in FIG. 6) which can be accomplished if the walls of the tube are smooth, and the tube is not too narrow, say, e.g., preferably larger than 2 cm in diameter or in thickness. In one embodiment, parameters can be chosen to optimize performance. In one example, an electrical impedance of the loudspeaker at the working frequency F_{b} is about twice that of the impedance at Direct Current (DC).

If the Direct Current (DC=zero frequency) resistance is measured for the system (loudspeaker mounted in the cavity) then this is called the voice coil DC resistance (Z(DC)).

If we measure the electrical resistance at the working frequency (loudspeaker mounted in the cavity), we call this Z(f_{work}=F_{b}), now we demand that Z(f_{work}) is about 2*Z(DC), this means that the loudspeaker and the housing fit well together, and they are optimally tuned. This will be referred to hereinafter as tuning criteria. Other tuning criteria may be employed as well. For example, it is preferable that the electrical impedance at the working frequency is about twice the direct current impedance; however, in other embodiments the electrical impedance at a lowest working frequency is equal to the anti-resonant frequency that is between about 1 time and about 3.5 times a direct current impedance, and preferably between about 1.75 and about 2.25 times.

Referring to FIG. 5, a specified frequency f_{work} is selected to substantially coincide with an anti-resonance frequency as shown as F_{b}. The anti-resonance frequency F_{b} is that frequency at which an electrical input impedance curve (Z(Ω)) reaches a local minimum between the first two impedance peaks 402 and 404 (seen from the left on the frequency scale). The impedance peaks 402 and 404 correspond to the natural or resonance frequencies of the system including chamber 104 (204) and tube 106 (206), or in FIG. 4, the natural frequency of the loudspeaker 302 and tube 306. The natural frequencies f1 and f2 may be selected by selecting the loudspeaker (driver) properties and the dimensions of the chamber and pipe.

F_{b} may then be selected or measured and employed as the operating frequency of the device. An advantage in selecting F_{b} is that a low cost, compact and light weight alarm is realized with improved audibility for the hearing impaired, or for use in difficult conditions like high damping by walls. This is realized due at least to the operating frequency being lower than conventional devices. In addition, by employing a loudspeaker, such as those found in a radio or other devices, multiple tones can be achieved. In one embodiment, the loudspeaker may provide more than one tone at the same time.

Referring to FIG. 5 and FIG. 6, a chamber, loudspeaker and elongated shaped cavity (106, 206 and/or 306 in FIGS. 2, 3, and 4, respectively) form a resonating system. The elongated shaped cavity may include a tube with a circular (oval or circle cross-section), a rectangular (e.g., a rectangular or square cross-section) or any other shaped cross-section. This structure preferably provides audible sound substantially at an anti-resonant frequency between first and second resonant frequency peaks (FIG. 5) of the system impedance. In other words, a 1st peak (502) of FIG. 6 coincides with the minimum between the peaks 402 and 404 of FIG. 5 (at frequency F_{b}). Note the vertical axis of FIG. 6 is SPL (dB) and that of FIG. 5 is the magnitude of the electrical impedance in ohms.

Tube dimensions and loudspeaker size are preferably selected such that, at the anti-resonance frequency F_{b}, an electrical impedance of the system is twice that of the DC impedance, although other criteria may be employed. The frequency of the alarm tone can be changed such that it is optimally audible by a subject. In one embodiment, the length of the tube or cavity (106, 206 or 306) may be adjusted such that the tuning criteria are fulfilled. This can be achieved by making, e.g., the tube telescopic (e.g., like a car antenna) such that the length can be optimized and adjusted.

In another embodiment, the anti-resonant frequency can be adjusted by adjusting the characteristics of the pipe or chamber. The tuning may be performed to increase the chance of hearing a particular tone. For example, if a user of a smoke alarm has impaired hearing the alarm may be adjusted to a frequency range that is particularly audible for that user.

Referring again to FIG. 4, a small loudspeaker 302 is mounted onto/into a tube 306. Tube 306 may be bent or folded in any direction. An example of the acoustical response of a prototype is shown in FIG. 6. For illustrative purposes, a diameter, Dₚ, and length, Lₚ, of the tube are respectively 3 cm and 15 cm, and a diameter of the loudspeaker is 2.4 cm.

In the illustrative embodiment of FIG. 4, the following parameters were employed to perform tests. For the loudspeaker 302: R_{E}=6.6Ω (DC resistance), R_{M}=0.49 Ns/m (mechanical resistance of the loudspeaker mounting suspension), B1=2.56 N/A (motor force factor of the loudspeaker), S₁=0.000452 m² (loudspeaker area), D₁=0.024 m (effective. diameter of the loudspeaker), fₛ=360 Hz (resonant frequency of the loudspeaker), and m₁=0.00057 kg (moving mass of the loudspeaker). For the system: V₁=1 cm³ (chamber volume), Lₚ=15 cm (pipe or tube 306 length), Dₚ=30 mm (diameter of the tube 306). It should be understood that these parameters are for illustration purposes and should not be construed as limiting.

Referring to FIG. 6, SPLs of the prototype described in FIG. 4 with the illustrative parameters are shown for various voltages for the fundamental frequency. The voltages 1V-6V represent the loudspeaker power voltage, which is preferably DC power (e.g., from a battery). It should be noted that other power sources may be employed, such as AC power, and employ a transformer or provide power directly to the loudspeaker or its controlling circuitry. The highest voltage provides the highest SPL for all plots. The working frequency coincides with the peak 502 in FIG. 6, which is preferably less than 1000 Hz and in this example (e.g., the prototype) is about 550 Hz.

In a preferred embodiment, more than one tone may be present at the same time. These tones preferably include frequencies coincident with the peaks of FIG. 6, in order to get high audibility and attention. In other words, resonant peaks 502, 504 and the peaks with higher frequencies in FIG. 6 (to the right of 504) would be coincident for two or more tones. In another embodiment, the loudspeaker can be employed to render voice messages.

The peaks in FIG. 6 are determined mainly by the loudspeaker enclosure (including the pipe), so it is better to adjust the tones such that the tones substantially remain below 1000 Hz. In one embodiment, tones can be adjusted automatically by sensing the impedance of the system (measuring the current through the loudspeaker and the voltage across the loudspeaker) and tuning the frequency (by adjusting the cavity or the loudspeaker) so that a desired frequency or frequencies are obtained.

There can be two or more tones that may share the same peaks or which may share at least one peak with another tone. For example, a first tone may have at least peaks 502 and 504. The first tone may be employed with a second tone both with a frequency at the first peak (502) of FIG. 6, and a third tone may have a frequency at the 2nd peak (504) of FIG. 6. The tones are preferably present at the same time, they may alternate in order to get more attention.

Referring to FIG. 7, an alarm device 600 is illustratively shown in accordance with one application. Alarm device 600 may be a smoke detector, a fire alarm, a carbon monoxide detector or any other device configured to sense a condition and provide an audible alert. Device 600 includes a power source 608, which may include a battery or other known power source(s). Power source 608 may be switched on by a switch 610 or other device to initiate operations (e.g., sensing conditions or activating loudspeaker (LS) 614). One or more sensors 604 are preferably provided to sense environment conditions to activate audible alarm device 620.

Alarm device 620 may also be activated manually by activating a switch (e.g., switch 610) depending on the application or mode of operation. For example, if the device 600 is employed as a carbon monoxide detector, when carbon monoxide levels exceed a threshold (which may be stored in memory 606) as measured by a sensor 604 (a processor/controller 612 may perform the comparison), then alarm device 620 is activated by powering loudspeaker 614.

Other events may be employed to trigger activation of alarm device 620. For example, alarm device 620 may be activated after a predetermined amount of time (e.g., alarm clock or class bell). The alarm device can be used for acoustical alarms and evacuation signals, or as a personal alarm, crime deterrent device (e.g., for ladies to carry the device in their bag, etc.) or integrated in a bicycle, car, or other platform (e.g., an alarm for a clock radio, personal digital assistance (PDA), telephone ring tone generator, etc.). Processor/controller 612 supplies power and signal to the alarm device 620. Depending on the condition or triggered sensor 604, different tones, voices or combinations thereof may be provided to the loudspeaker 614. The system 600 can render coded messages by using different frequencies or combinations, e.g. one for smoke, one for CO, etc. Other alarm mechanisms may be employed as well, such as lights, for example.

Alarm device includes a chamber 616 and tube 618 which have the characteristics as described above in accordance with the present principles. Chamber 616 may be reduced to a small volume as depicted in FIG. 4. The tube 618 preferably has small acoustical damping, and may be curved or bent in any direction to save space or to direct the sound in a particular direction. Tube 618 may include an adjustment mechanism 622 to adjust the audible tone output. Adjustment mechanism 622 may add mass to the system, constrict the cross-section of tube 618, add damping, and/or extend the length of the cavity 618 (e.g., telescoping). Adjustment may be performed manually using a mechanical device 624 such as a spring or screw driven against the tube 618, or the adjustment can be processor controlled based on user input or acoustic feedback from one of the sensors 604. Adjustment may also be made to the loudspeaker power or output to affect user fed back changes. For example, voltage and current measurements may be made on the loudspeaker to determine impedances and optimizing adjustments may be made.

Referring to FIG. 8, a flow diagram showing a method for sounding an alarm is shown in accordance with the present principles. In block 702, an alert device is provided that includes an elongated cavity and a loudspeaker coupled to a first end portion of the cavity wherein sound produced by the loudspeaker is directed through the cavity to provide an audible sound. In block 704, the cavity and the loudspeaker are configured to provide the audible sound substantially at an anti-resonant frequency between first and second resonant frequency peaks for system impedance in a response spectrum for the loudspeaker and the cavity. For example, the audible sound may include at least one of a plurality of tones and voice messages. The plurality of tones may each include a fundamental frequency peak at a substantially same frequency. Configuring the cavity and the loudspeaker may also include configuring the chamber that houses the loudspeaker. An electrical impedance may provide a working frequency equal to the anti-resonant frequency that is between about 1 time and about 3.5 times a direct current impedance. Configuring the system may also include making adjustment to the chamber, cavity and loudspeaker to meet the impedance criteria or other criteria. This may include altering the characteristics of the system using, e.g., an adjustment mechanism (622) or employing feedback to adjust the acoustic response. In block 706, the audible sound is generated by activating the loudspeaker.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) no specific sequence of acts is intended to be required unless specifically indicated.

Having described preferred embodiments for an alarm device and method (which are intended to be illustrative and not limiting), it is noted that modifications and variations can be made by persons skilled in the art in light of the above teachings. It is therefore to be understood that changes may be made in the particular embodiments of the disclosure disclosed which are within the scope and spirit of the embodiments disclosed herein as outlined by the appended claims.

Having thus described the details and particularity required by the patent laws, what is claimed and desired protected by Letters Patent is set forth in the appended claims.

1. An alert device, comprising:
an elongated cavity; (306) and
a loudspeaker (302) coupled to a first end portion of the cavity wherein sound produced by the loudspeaker is directed through the cavity to provide an audible sound;
the cavity and the loudspeaker are configured and dimensioned to provide the audible sound substantially at an anti-resonant frequency (F_{b}) between first and second resonant frequency peaks for system impedance in a response spectrum for the loudspeaker and the cavity.

2. The device as recited in claim 1, wherein the loudspeaker (202) is mounted in a chamber (204), the chamber being in acoustic communication with the cavity.

3. The device as recited in claim 1, wherein the loudspeaker (102) is mounted in a chamber (104), the loudspeaker dividing the chamber into two volumes (V0, V1) such that one volume is in acoustic communication with the cavity.

4. The device as recited in claim 1, wherein the alert device is activated by one of a smoke detector, a fire alarm, and a carbon monoxide detector.

5. The device as recited in claim 1, wherein the audible sound includes a plurality of tones.

6. The device as recited in claim 5, wherein the plurality of tones share at least one peak frequency.

7. The device as recited in claim 1, wherein the audible sound includes voice messages.

8. The device as recited in claim 1, wherein the alert device includes an electrical impedance at a lowest working frequency equal to the anti-resonant frequency that is between about 1 time and about 3.5 times a direct current impedance.

9. The device as recited in claim 1, wherein the alert device includes an electrical impedance at a lowest working frequency equal to the anti-resonant frequency that is between about 1.75 times and about 2.25 times a direct current impedance.

10. The device as recited in claim 1, wherein the anti-resonant frequency is less than 1000 Hz.

11. A detector device, comprising:
a triggering device (604) configured to trigger an alarm signal in accordance with a condition;
an alert device (620) comprising a tube (618) and a loudspeaker (614) coupled to a first end portion of the tube wherein sound produced by the loudspeaker is directed through the tube to provide an audible sound, the tube and the loudspeaker are configured and dimensioned to provide the audible sound substantially at an anti-resonant frequency between first and second resonant frequency peaks for system impedance in a response spectrum for the loudspeaker and the tube; and
a controller (612) coupled to the triggering device and configured to activate the alert device in accordance with the alarm signal.

12. The device as recited in claim 11, wherein the loudspeaker (614) is mounted in a chamber (616), the chamber being in acoustic communication with the tube.

13. The device as recited in claim 11, wherein the loudspeaker (614) is mounted in a chamber (104), the loudspeaker dividing the chamber into two volumes (V0, V1) such that one volume is in acoustic communication with the tube.

14. The device as recited in claim 11, wherein the detector device includes one of a smoke detector, a fire alarm, and a carbon monoxide detector.

15. The device as recited in claim 11, wherein the audible sound includes a plurality of tones.

16. The device as recited in claim 15, wherein the plurality of tones share at least one peak frequency.

17. The device as recited in claim 11, wherein the audible sound includes voice messages.

18. The device as recited in claim 11, wherein the alert device includes an electrical impedance at a lowest working frequency equal to the anti-resonant frequency that is between about 1 time and about 3.5 times a direct current impedance.

19. The device as recited in claim 11, wherein the alert device includes an electrical impedance at a lowest working frequency equal to the anti-resonant frequency that is between about 1.75 times and about 2.25 times a direct current impedance.

20. The device as recited in claim 11, wherein the anti-resonant frequency is less than 1000 Hz.

21. The device as recited in claim 11, further comprising a mechanism (622) for adjusting the anti-resonant frequency.

22. The device as recited in claim 11, wherein the triggering device (604) includes one of a sensor, a clock, and a manual activation.

23. A method for sounding an alarm, comprising:
providing (702) an alert device including an elongated cavity and a loudspeaker coupled to a first end portion of the cavity wherein sound produced by the loudspeaker is directed through the cavity to provide an audible sound;
configuring (704) the cavity and the loudspeaker to provide the audible sound substantially at an anti-resonant frequency between first and second resonant frequency peaks for system impedance in a response spectrum for the loudspeaker and the cavity; and
generating (706) the audible sound by activating the loudspeaker.

24. The method as recited in claim 23, wherein the audible sound includes at least one of a plurality of tones and voice messages.

25. The method as recited in claim 23, wherein configuring (704) includes providing an electrical impedance at a lowest working frequency equal to the anti-resonant frequency that is between about 1 time and about 3.5 times a direct current impedance.
